(19) United States
(12) Patent Application Publication
(10) Pub. No.: US 2005/0113543 A1
(43) Pub. Date: May 26, 2005

(54) Alpha, omega-allyl terminated linear poly(methacrylic acid) macromonomers for end-linked hydrogels and method of preparation

(76) Inventors: Jeffrey T. Koberstein, Storrs, CT (US); Lucy Vojtova, Brno (CZ); Nicholas J. Turro, Tenafly, CT (US)

Correspondence Address: BAKER & BOTTS, 30 ROCKEFELLER PLAZA, NEW YORK, NY, 10112, US

(21) Appl. No.: 10/975,772

(22) Filed: Oct. 28, 2004

Related U.S. Application Data
(63) Continuation of application No. PCT/US02/17636, filed on Jun. 3, 2002.

(51) Int. Cl. C08F 120/68

(52) U.S. Cl. 526/318

(57) ABSTRACT

Disclosed is a method for making α,ω-allyl terminated macromonomers comprising a plurality of units of an α,β-unsaturated carboxylic acid. The method comprises forming a first mixture containing an ester of an α,β-unsaturated carboxylic acid, a radical initiator comprising an allyl group and a halogen, and a catalyst comprising a transition metal complex. The ester of the α,β-unsaturated carboxylic acid is an ester capable of reacting with a mixture comprising trifluoroacetic acid (TFA) to form the α,β-unsaturated carboxylic acid. The mixture is stirred to form a second mixture containing an α-allyl, ω-halogen-terminated macromonomer comprising a plurality of units of the ester of the α,β-unsaturated carboxylic acid. A third mixture comprising a compound containing at least one transferable allyl group is then added to the second mixture to form a fourth mixture containing a first α,ω-allyl terminated macromonomer comprising a plurality of units of the ester of the α,β-unsaturated carboxylic acid. The first α,ω-allyl terminated macromonomer is separated from the fourth mixture and is mixed with a mixture containing TFA to form a fifth mixture containing the α,ω-allyl terminated macromonomer comprising a plurality of units of the α,β-unsaturated carboxylic acid. The α,ω-allyl terminated macromonomer comprising a plurality of units of the α,β-unsaturated carboxylic acid is then separated from the fifth mixture. Also enclosed is a related method for making end-linked hydrogels comprising a plurality of units of an α,β-unsaturated carboxylic acid. The method comprises forming a first mixture containing an α,ω-allyl terminated macromonomer comprising a plurality of units of the α,β-unsaturated carboxylic acid and a radical initiator. The first mixture is treated with UV-radiation, visible light, or heat to form a second mixture comprising an end-linked hydrogel comprising a plurality of units of the α,β-unsaturated carboxylic acid.

This work was supported by the National Institutes of Health, the National Science Foundation (Grant NSF-CHE01-10655) and in part by the MRSEC Program of the National Science Foundation under Award Number DMR-9809687.

### BACKGROUND OF THE INVENTION

1. Field of the Invention

The invention is directed to α,ω-allyl terminated macromonomers and to functionalized end-linked hydrogels. In particular, the invention is directed to α,ω-allyl terminated poly(methacrylic acid)macromonomers and to end-linked hydrogels containing units of methacrylic acid.

2. Background Information

Hydrogels are chemically or physically crosslinked polymeric networks that exhibit the ability to swell in water without dissolving. Owing to their biocompatibility, special surface properties and high water content, hydrogels have been the material of choice in many biomedical applications, as described in Wichterle, O. and Lim, D., Nature, Vol. 185 (1960), p. 117. For example, hydrogels have been used as diagnostic or therapeutic devices and implantable biosensors for short-term or long-term applications. See Hoffmnan, A. S., Benoit, H. and Remptt, P., Macromolecules, Pergamon Press, New York (1982), pp. 321-335. A major obstacle to the widespread application of implantable biosensors is the loss of sensitivity after a relatively short period of time in vivo resulting from fibrous incapsulation and other detrimental tissue responses to the sensor, as discussed in Schishiri, M., Asakawa, N., Yamasaki, Y., Kuwamori, R. and Abe, H., Diabetes Care, Vol. 9 (1986), pp. 298-301.

Cell attachment to the implanted polymeric material plays an important role in determining tissue compatibility. Cell-polymer interactions are believed to be mainly dependent upon the physical and chemical properties of the material surface, surface free energy, microstructure, rigidity, hydrophilicity and hydrophilic-hydrophobic ratio, as disclosed in Mirzadeh, H., Katbab, A. A., Khorasani, M. T., Burford, R. P., Gorgin, E. and Golestani, A., Biomaterials, Vol. 16 (1995), pp. 641-648. It is believed that hydrogels based on hydrophilic 2-hydroxyethyl methacrylate (HEMA) monomer contain a significant amount of water, thereby exhibiting surface energy similar to that of the body tissues. See Hoffman, A. S., Journal of Biomedical Materials Research, Vol. 5 (1974), p. 77. However, poly(HEMA) hydrogels have certain disadvantages. They generally exhibit weak mechanical properties, although these can be enhanced either by increasing the amount of cross-linking or by combination with a hydrophobic comonomer via copolymerization or grafting while reducing water absorption. Another disadvantage of poly(HEMA)hydrogels is calcification. To minimize calcification, and thus suppress tissue inflammation and fibrosis, a poly(HEMA)hydrogel may be modified with methacrylic or acrylic acid, as disclosed in U. S. Pat. No. 3,985,697. A further disadvantage of poly(HEMA) gels is protein adsorption onto the gels. Protein adsorption can be reduced by addition of polyethylene glycol to the gel, as described in Quinn, C. P., Pathak, C. P., Heller, A. and Hubbel, J. A., Biomaterials, Vol. 16 (1995), pp. 389-396. However, the resulting heterogeneity of the polymeric network severely affects the physical properties of the final cross-linked materials, as discussed in Yu, Q., Zeng, F. and Zhu, S., Macromolecules, Vol. 34 (2001), pp.1612-18.

The preparation of homogeneous networks with well-defined molecular weight between crosslinks may be envisioned by radiation induced end-linking reactions of α,ω-fictional, or telechelic, linear macromonomers. Macromonomers are defined as oligomers with a number average molecular weight Mₙ between about 1,000 and about 10,000 that contain a functional group suitable for further polymerizations, and are described in Ito, K., Progress in Polymer Science, Vol. 23 (1998), pp. 581-620. The end-linking reaction can be carried out on a mixture of the α,ω-functional macromonomer, a suitable initiator and a solvent. A cross-linker is not required, and the molecular structure, and therefore also the mechanical properties, are determined by the macromonomer molecular weight and composition. Macromonomers allow for control of a wide variety of properties of the species prior to polymerization into final product. The ability to control rheological properties, such as viscosity, is useful in coating and adhesive applications. In contrast, monomers, by definition, are of low molecular weight and have low viscosities which are unfavorable for these types of applications. In addition, the use of macromonomers for the preparation of polymeric networks, especially when prepared by living polymerization, is widely regarded as a method of choice for forming well-defined copolymers of various architectures, such as various graft, block, star, dendritic and brash structures See Zeng, F., Shen, Y. and Pelton, R, Macromolecules, Vol. 33 (2000), p. 1628. These various types of copolymers allow for tailored achievement of many unique and useful properties, such as the modulation of the mechanical and transport properties of hydrogels through the control of the size and morphology of microphase-separated domains as described in Drumheller, P. D., Elbert, D. L. and Hubbell, J. A. Biotechnology & Bioengineering, Vol. 43 (1984), p. 772. In virtually every application of polymeric materials, and in particular in biomaterials and tissue engineering applications, strict control of these properties is critical, as described in Lee, M. H. M.S. Thesis, University of Connecticut (2000). However, such control is often not possible due to the polydisperse nature of polymers prepared from monomers by conventional synthetic methods.

Controlled or “living” polymerizations offer the possibility of synthesizing polymers with precise control of the end groups, composition, functionality and architecture of the polymer. See Zhang, X., Xia, J. and Matyjaszewski, K., Macromolecules, Vol. 33 (2000), pp. 2340-2345. However, living polymerizations based on anionic, cationic, or group transfer are very sensitive to moisture, oxygen and impurities, and are thus very difficult to carry out. Recently, the development of controlled/“living” free radical polymerization technique known as Atom Transfer Radical Polymerization (ATRP), described in Wang, J-S. and Matyjaszewski, K., Journal of the American Chemical Society, Vol. 117 (1995), p. 5641, has rendered possible the synthesis of a variety of well-defined polymers with low polydispersity indexes (M_{w}/Mₙ<1.3, where M_{w} is the weight average molecular weight) and predetermined molecular weights, defined by the relationship DP=Δ[M]/[I]₀, where DP is the degree of polymerization, [M] is the reacted monomer concentration, and [I]₀ is the initial concentration of the initiator. The mechanism of ATRP, shown in Scheme 1 hereinbelow, is believed to be based on the repetitive addition of a monomer M to growing radicals R• generated from alkyl halides R—X by a reversible redox process. This process is catalyzed by transition metal compounds, especially cuprous (Cu(I)) halides, complexed by suitable ligands such as bipyridines and bi-, tri- and tetradentate amines, as described in Xia, J., Zhang, X. and Matyjaszewski, K., American Chemical Society Symposium Series, Vol. 760 (2000), pp. 207-23. The rate of monomer addition is dependent on the equilibrium constant between the activated (Cu(I)) and deactivated (Cu(II)) species. By maintaining a low concentration of active radicals, slow growth of the molecular weight is promoted and the “living” ATRP process is controlled. The degree of polymerization is determined by the ratio of reacted monomer concentration to initiator concentration (DPₙ=Δ[M]/[R—X]₀).

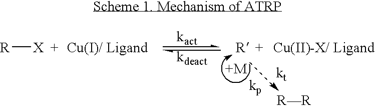

Radical reactions allow for polymerization of a large variety of vinyl monomers and are tolerant to many functional groups. ATRP is applicable to the reactions of hydrophobic monomers such as acrylates, methacrylates and styrene, as shown in Patten, T. E. and Matyjaszewski, K. Advanced Materials, Vol. 10 (1998), pp. 901-915, and also of hydrophilic and functional monomers such as 2-hydroxyethyl acrylate, 2-hydroxyethyl methacrylate, 2-(dimethylamino)ethyl methacrylate (DMAEMA) and 4-vinylpyridine. See Matyjaszewski, K, Gaynor, S. G., Qiu, J., Beers, K., Coca, S., Davis, K., Muhlebach, A., Xia, J. and Zhang, X., American Chemical Society Symposium Series, Vol. 765 (2000), pp. 52-71. Functional end groups, such as hydroxy, cyano, epoxy, allyl, vinyl, acetate, lactone and amide groups, can be introduced by use of either a functional initiator, see Gaynor, S. G. and Matyjaszewski, K. American Chemical Society Symposium Series, Vol. 768 (2000), pp. 347-360, or through the transformation of the halogen end group, including nucleophilic substitution with azide and hydroxy groups, and radical reactions to transfer hydrogen atoms and allyl groups. See Matyjaszewski, K, Nakagawa, Y. and Gaynor, S. G., Macromolecular Rapid Communications, Vol. 18. (1997), pp. 1057-1066; Coessens, V. and Matyjaszewski, K., Macromolecular Rapid Communications, Vol. 20 (1999), pp. 127-134; Coessens, V. and Matyjaszewski, K. Macromolecular Rapid Communications, Vol. 20 (1999), pp. 66-70; and Coessens, V., Pyun, J., Miller, P. J., Gaynor, S. and Matyjaszewski, K., Macromolecular Rapid Communications, Vol. 21 (2000), pp. 103-109. ATRP can also be used to prepare macromonomers. In particular, the syntheses of polystyrene macromonomers using vinyl chloroacetate and allyl bromide as initiators has been reported in Matyjaszewski, K., Beers, K., Kern, A. and Gaynor, S. G., Journal of Polymer Science, Part A: Polymer Chemistry, Vol. 36 (1998), p. 823 and in Nakagawa, Y. and Matyjaszewski, K. Polymer Journal, Vol. 30 (1998), p. 138. Similarly, DMAEMA macromonomers have been prepared using 2-bromoisobutyrate and MMA as described by Zeng et al., above. DMAEMA and styrene macromonomers have been prepared using 2-vinyloxyethyl 2-bromoisobutyrate and 3-vinyloxypropyl trichloroacetamide, as reported in Shen, Y., Zhu, S., Zeng, F. and Pelton, R., Macromolecules, Vol.33 (2000), pp.5399-404.

A disadvantage of ATRP is its sensitivity to the presence of acid functionalities, which renders it inapplicable for polymerization reactions of monomers or initiators containing such functionalities. The detrimental effect of the acid functionality on ATRP is believed to be due either to the displacement of the halogen atom on the copper complex by the anion of the acid functionality or to protonation of the nitrogen based ligand which disrupts its coordination to the metal center of the catalyst. See Davis, K. A. and Matyjaszewski, K., Macromolecules, Vol. 33 (2000), pp. 4039-4047. To avoid these difficulties, monomers with protected acid groups are polymerized followed by a deprotection step to regenerate the desired acid functionality. The deprotection of t-butyl groups from poly(t-butyl acrylate) to afford poly(acrylic acid) has been successfully performed using hydrochloric acid in dioxane, as described in Zhang et al., above. However, this approach is ineffective for the removal of t-butyl groups from poly-t-butyl methacrylate (poly-(t-BMA)). This is believed to be due to the very high hydrophobicity of poly(t-BMA) macromonomers that suppress the protonation of ester groups.

Accordingly, a need exists in the art for an efficient method based on ATRP for making telechelic macromonomers containing carboxylic functionalities within the chain. A need also exists for an efficient method for making hydrogels containing carboxylic functionalities and prepared from the telechelic macromonomers.

### SUMMARY OF THE INVENTION

The above-described need in the art is substantially satisfied by the present invention, which in one aspect is a method for making α,ω-allyl terminated macromonomers comprising a plurality of units of an α,β-unsaturated carboxylic acid. The method comprises providing a first mixture comprising an ester of an α,β-unsaturated carboxylic acid, a radical initiator comprising an allyl group and a halogen, and a catalyst comprising a transition metal complex. The ester of the α,β-unsaturated carboxylic acid is an ester capable of reacting with a mixture comprising trifluoroacetic acid (TFA) to form the α,β-unsaturated carboxylic acid. The mixture is stirred to form a second mixture comprising an α-allyl,ω-halogen-terminated macromonomer having a plurality of units of the ester of the α,β-unsaturated carboxylic acid. A third mixture comprising a compound containing at least one transferable allyl group is then added to the second mixture to form a fourth mixture comprising an α,ω-allyl terminated macromonomer having a plurality of units of the ester of the α,β-unsaturated carboxylic acid. The α,ω-allyl terminated macromonomer is separated from the fourth mixture, and is mixed with TFA or with a mixture comprising TFA and an organic solvent to form a fifth mixture comprising an α,ω-allyl terminated macromonomer comprising a plurality of units of the α,β-unsaturated carboxylic acid The α,ω-allyl terminated macromonomer is then separated from the fifth mixture.

The invention in another aspect is a method for making end-linked hydrogels comprising a plurality of units of an α,β-unsaturated carboxylic acid. The method comprises providing a first mixture including an α,ω-allyl terminated macromonomer having a plurality of units of the α,β-unsaturated carboxylic acid and a radical initiator. The first mixture is treated with UV-radiation, visible light, or heat to form a second mixture comprising an end-linked hydrogel having a plurality of units of the α,β-unsaturated carboxylic acid.

The invention in another aspect is a method for making end-linked hydrogels having a plurality of units of an α,β-unsaturated carboxylic acid. The method comprises providing a first mixture comprising an α,ω-allyl terminated macromonomer having a plurality of units of an ester of the α,β-unsaturated carboxylic acid. The ester of the α,β-unsaturated carboxylic acid is an ester capable of reacting with a mixture comprising trifluoroacetic acid (TFA) to form the α,β-unsaturated carboxylic acid. The first mixture is treated with UV-radiation, visible light, or heat to form a second mixture comprising an end-linked gel having a plurality of units of ester of the α,β-unsaturated carboxylic acid. The second mixture is then mixed with a mixture containing trifluoroacetic acid (TFA) to form a third mixture including an end-linked hydrogel having a plurality of units of the α,β-unsaturated carboxylic acid. The end-linked hydrogel is then separated from the mixture.

The invention in another aspect is directed to an α,ω-allyl terminated macromonomer comprising a plurality of units of an α,β-unsaturated carboxylic acid.

The invention in another aspect is directed to an end-linked hydrogel comprising a plurality of units of an α,β-unsaturated carboxylic acid prepared by the method of the invention.

The invention in another aspect a method for making macromonomers having a plurality of units of an α,β-unsaturated carboxylic acid and terminated with an allyl group at a first end and an allyl group at a second end. The method comprises mixing a macromonomer having a plurality of units of an ester of an α,β-unsaturated carboxylic acid with a first mixture containing trifluoroacetic acid (TFA) to form a second mixture comprising a macromonomer having a plurality of units of the α,β-unsaturated carboxylic acid. The macromonomer having a plurality of units of the α,β-unsaturated carboxylic acid is then separated from the second mixture.

The invention has the advantage of providing hydrogels with controlled molecular structure, and thus controlled mechanical properties, which are useful in coating and adhesive applications. In addition, the hydrogels have reactive carboxylic functionalities located at regular intervals and thus have the ability to be covalently bound to so-called Tissue Response Modifiers (TRM) such as cell addition ligands, growth factors, cytokines and neutralizing antibodies for biosensor applications. The invention also has the advantage of providing a new class of macromonomers suitable as toughening agents for polymers such as acrylates.

### BRIEF DESCRIPTION OF THE DRAWINGS

FIG. 1 shows a plot of monomer conversion into the macromonomer versus reaction time for the t-BMA ATRP reaction in tetrahydrofuran (THF) (□), benzene (Δ) and acetone (ο).

FIG. 2 shows a plot of In ([M]₀/[M]) versus reaction time for the t-BMA ATRP reaction in THF(□), benzene (Δ) and acetone (ο).

FIG. 3 shows a plot of the number average molecular weights (Mₙ) versus monomer conversion for the t-BMA ATRP reaction in THF(□), benzene (Δ) and acetone (ο).

FIG. 4 shows a plot of polydispersity index (M_{w}/Mₙ) versus monomer conversion for the t-BMA ATRP reaction in THF(□), benzene (Δ) and acetone (ο).

FIG. 5 shows a ¹H NMR spectrum in CDCl₃ of an α-allyl terminated poly(t-BMA) macromonomer.

FIG. 6 shows a plot of ln ([M]₀/[M]) versus reaction time for the ATRP of t-BMA in benzene at 60° C.

FIG. 7 shows a plot of Mₙ versus monomer conversion for the ATRP of t-BMA in benzene at 60° C.

FIG. 8 shows a plot of M_{w}/Mₙ versus monomer conversion for the ATRP of t-BMA in benzene at 60° C.

FIG. 9 shows a Gel Permeation Chromatography (GPC) of a poly(t-BMA) macromonomer (peak 1) prepared by the ATRP of t-BMA, an extended poly(t-BMA) macromonomer (peak 2), and a further extended poly (t-BMA) macromonomer (peak 3).

FIG. 10 shows the molecular weight profile of an α-allyl,ω-bromine terminated poly(t-BMA)macromonomer formed in the ATRP reaction of t-BMA as a function of reaction time.

FIG. 11A shows a ¹H NMR spectrum of an α-allyl,ω-bromine terminated poly(t-BMA) macromonomer.

FIG. 11B shows a ¹H NMR spectrum of an α,ω-allyl terminated poly(t-BMA) macromonomer after reaction of the α-allyl,ω-bromine terminated poly(t-BMA) macromonomer of FIG. 11A with ATBT.

FIG. 12A shows a Matrix Assisted Laser Desorption/Ionization Time of Flight (MALDI-TOF) mass spectrum of an α-allyl,ω-bromine terminated poly(t-BMA) macromonomer.

FIG. 12B shows a MALDI-TOF mass spectrum of an α,ω-allyl terminated poly(t-BMA) macromonomer after reaction of the α-allyl,ω-bromine terminated poly(t-BMA) macromonomer.

FIG. 13A shows a ¹H NMR spectrum in D₂O of an α,ω-allyl terminated polymethacrylic acid (poly(MAA)) macromonomer prepared by reaction of the corresponding α,ω-allyl terminated poly(t-BMA) macromonomer with 95% TFA.

FIG. 13B shows a ¹H NMR spectrum of the α,ω-allyl terminated poly(MAA) macromonomer in deuterated DMSO.

FIG. 13C shows a ¹H NMR spectrum in deuterated DMSO of an α,ω-allyl terminated poly(MAA) macromonomer prepared by reaction of the corresponding Δ,ω-allyl terminated poly(t-BMA) macromonomer with concentrated (99%) TFA.

FIG. 14 shows a magnification of the 0.8-2.0 ppm region of the ¹H NMR spectrum of the α,ω-allyl terminated poly(MAA) macromonomer of FIG. 13C (dashed line).

FIG. 15A shows an FT-IR spectrum of an α,ω-allyl terminated poly(t-BMA) macromonomer.

FIG. 15B shows an FT-IR spectrum of the α,ω-allyl terminated poly(MAA) macromonomer obtained by deprotection of the α,ω-allyl terminated poly(t-BMA) macromonomer.

### DETAILED DESCRIPTION OF THE INVENTION

As used herein, the term “α,ω-allyl terminated macromonomer” refers to a macromonomer having an allyl group at each end of the macromonomer chain, and the term “α-allyl,ω-halogen-terminated macromonomer” refers to a macromonomer having an allyl group at one end of the macromonomer chain and a halogen atom at the other end of the macromonomer chain.

As used herein, the term “poly(t-BMA) macromonomer” refers to a macromonomer comprising a multiplicity of t-butyl methacrylate (t-BMA) units, and the term “poly(MAA) macromonomer” refers to a macromonomer comprising a multiplicity of methacrylic acid (MAA) units.

As used herein, the term “halogen” is intended to mean fluorine, chlorine, bromine, iodine, or a pseudohalogen group, such as, for example, a thiocyanate or a thiocarbamate.

As used herein, the term “units of an α,β-unsaturated carboxylic acid” refers to units having the formula I shown hereinbelow. The term “units of an ester of an α,β-unsaturated carboxylic acid” refers to units having the formula II shown hereinbelow.

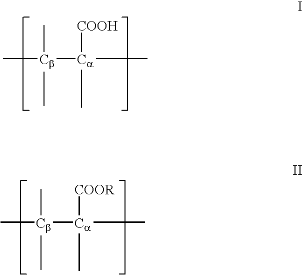

The α,β-unsaturated carboxylic acid may be any α,β-unsaturated carboxylic acid in which the C_{β}═C_{α} double bond is polymerizable. Advantageously, the α,β-unsaturated carboxylic acid is selected from the group consisting of α,β-unsaturated carboxylic acids having a C_{β}═C_{α} double bond in which the C_{β} carbon is bonded to two hydrogen atoms. Acrylic acid and methacrylic acid are especially suitable α,β-unsaturated carboxylic acids.

The ester of the α,β-unsaturated carboxylic acid which is capable of reacting with a mixture comprising trifluoroacetic acid to form the α,β-unsaturated carboxylic acid is advantageously an ester comprising the group having the formula III shown hereinbelow, in which R is a t-butyl group or a group having the formula Ar—(CR₁R₂)—, wherein Ar is an aryl group and R₁ and R₂ are each independently hydrogen, an alkyl group or an aryl group and may be the same or different. t-butyl methacrylate and phenylmethyl methacrylate are especially suitable esters.

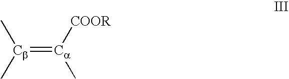

The radical initiator having an allyl group and a halogen may be any radical initiator commonly used for polymerization reactions. Advantageously, the radical initiator having an allyl group and a halogen is a compound having a carbon-halogen bond and a carbon a to the carbon bonded to the halogen, wherein the α-carbon bears an activating substituent which is preferably one of substituted or unsubstituted aryl, carbonyl, and substituted or unsubstituted allyl. Allyl-2-bromoisobutyrate (ABIB) is an especially suitable radical initiator.

The transition metal of the transition metal complex is advantageously selected from molybdenum, chromium, rhenium, ruthenium, iron, rhodium, nickel, palladium and copper. The transition metal complex comprises a counteranion which is advantageously a monovalent anion, such as the halogen anions or the acetate anion. The transition metal complex comprises a ligand which is advantageously selected from the group of amines, phosphines, arenes, and monovalent anions. Particularly suitable ligands are C₆H₄(CH₂NMe₂)₂, 2,6-bis[(dimethylamino)methyl]pyridine, N(nBu)₃, phenanthroline, substituted or unsubstituted picolylamine, N,N,N′,N′,N″,N″-hexamethyltriethylenetetraamine, P(nBu)₃, triphenylphosphine, isopropyltoluene, indenyl, cyclopentadienyl, chloride, bromide, and iodide. The 1:1 complex of copper bromide with N,N,N′,N′,N″,N″-hexamethyltriethylenetetraamine (HMTETA) is an especially suitable transition metal complex.

The compound containing at least one transferable allyl group can be any compound that can react with the macromonomer containing a terminal bromine by replacing the terminal halogen of the α-allyl,ω-halogen terminated macromonomer with the allyl group. Without wishing to be bound by any theory or mechanism, it is believed that the replacement of bromine with the allyl group occurs via nucleophilic substitution, electrophilic addition, or radical reaction. Advantageously, the compound containing at least one allyl group is an allylmetal. Allyltributyltin is an especially suitable compound.

The radical initiator used in the end-linking reaction may be any radical initiator commonly used for polymerization reactions. Advantageously, the radical initiator is selected from 2,2′-azobis(2-methyl-propionitrile) (AIBN) and, 2,2-dimethoxy-2-phenylacetophenone (DMPA).

The mixture containing trifluoroacetic acid is advantageously a mixture of trifluoroacetic acid and water containing at least 95% of trifluoroacetic acid by volume. A mixture of trifluoroacetic acid and water containing 99% of trifluoroacetic acid by volume is especially suitable. The mixture of trifluoroacetic acid and water containing 99% of trifluoroacetic acid by volume is hereinafter referred to as “concentrated trifluoroacetic acid.”

Separation of a macromonomer, gel or hydrogel from a mixture may be accomplished by using methods which are well-known in the field. An advantageous method for the separation of a macromonomer from a mixture includes the step of chromatography of the mixture using a first solvent or mixture of solvents in which the macromonomer is soluble to form a new mixture which contains the first solvent or mixture of solvents and the macromonomer. This step may be followed by the step of addition to the new mixture of a second solvent or mixture of solvents in which the macromonomer is insoluble to cause precipitation of the macromonomer, which is then isolated by filtration. Another advantageous method for the separation of a macromonomer from a mixture includes the step of continuous extraction of the macromonomer from the mixture, which may be accomplished, for example, by using a Soxhlet apparatus. An advantageous method for the separation of a gel or hydrogel from a mixture includes washing the gel or hydrogel with a solvent in which the impurities are soluble and the gel or hydrogel is insoluble.

In accordance with a first embodiment of the present invention, end-linked hydrogels having a multiplicity of units of an α,β-unsaturated carboxylic acid are prepared according to Scheme 2A shown hereinbelow. An α-allyl,ω-halogen terminated poly(t-BMA) macromonomer is first prepared by ATRP. The ω-halogen is then transformed into a second allyl group by reaction with allyltributyltin to give an α,ω-allyl terminated poly(t-BMA) macromonomer. Deprotection of the t-butyl groups of the macromonomer by TFA produces an α,ω-allyl terminated polymethacrylic acid (poly(MAA)) macromonomer. The macromonomer is then treated with UV-radiation, visible light, or heat to form the end-linked hydrogel.

In accordance with a second embodiment of the present invention, end-linked hydrogels having a multiplicity of units of an α,β-unsaturated carboxylic acid are prepared according to Scheme 2B shown hereinbelow. An. α-allyl,ω-halogen terminated poly(t-BMA) macromonomer is first prepared by ATRP. The ω-halogen is then transformed into a second allyl group by reaction with allyltributyltin to give an α,ω-allyl terminated poly(t-BMA) macromonomer. The macromonomer is then treated with UV-radiation, visible light, or heat to form an end-linked gel having a multiplicity of units of the t-butyl ester of an α,β-unsaturated carboxylic acid. Deprotection of the t-butyl groups of the gel by TFA gives the end-linked hydrogel.

In accordance with a third embodiment of the present invention, α,ω-allyl terminated macromonomers are prepared according to steps 1-3 of Scheme 2A shown hereinbelow, in which the mixture containing an ester of an α,β-unsaturated carboxylic acid, a radical initiator having an allyl group and a halogen, and a catalyst having a transition metal complex further contains an organic solvent. Advantageously, the organic solvent is selected from one of acetone, benzene and tetrahydrofuran. If the solvent is benzene or tetrahydrofuran, the mixture is stirred at a temperature of about 60° C. to form the mixture containing an α-allyl,ω-halogen-terminated macromonomer having a multiplicity of units of the ester of the α,β-unsaturated carboxylic acid. If the solvent is benzene or tetrahydrofuran, the mixture is stirred at a temperature of about 50° C. to form the mixture containing an α-allyl,ω-halogen-terminated macromonomer having a multiplicity of units of the ester of the α,β-unsaturated carboxylic acid.

In accordance with a fourth embodiment of the present invention, α,ω-allyl terminated macromonomers are prepared according to steps 1-3 of Scheme 2A shown hereinbelow, in which the mixture containing an ester of an α,β-unsaturated carboxylic acid, a radical initiator having an allyl group and a halogen, and a catalyst having a transition metal complex does not contain a solvent.

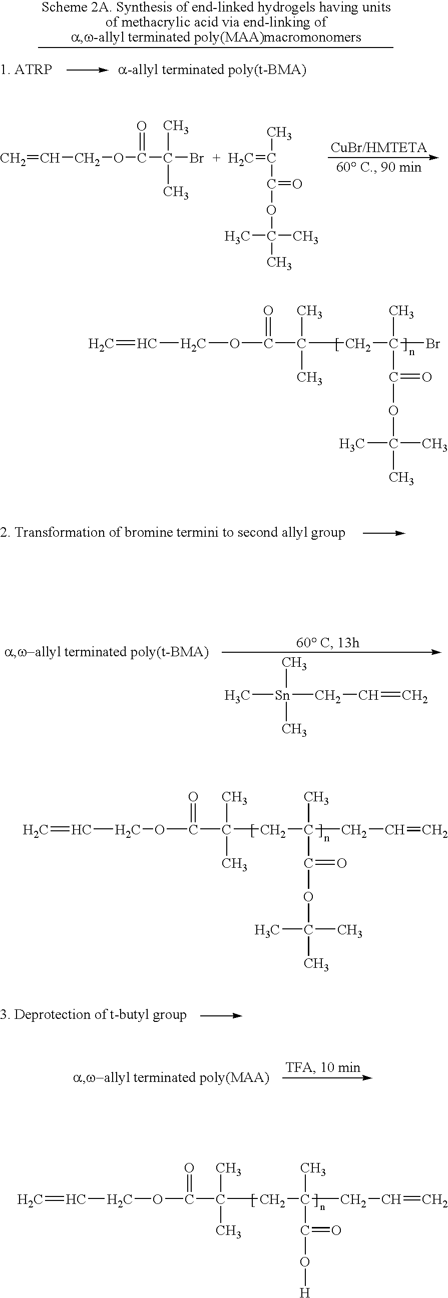

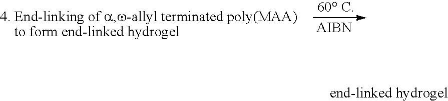

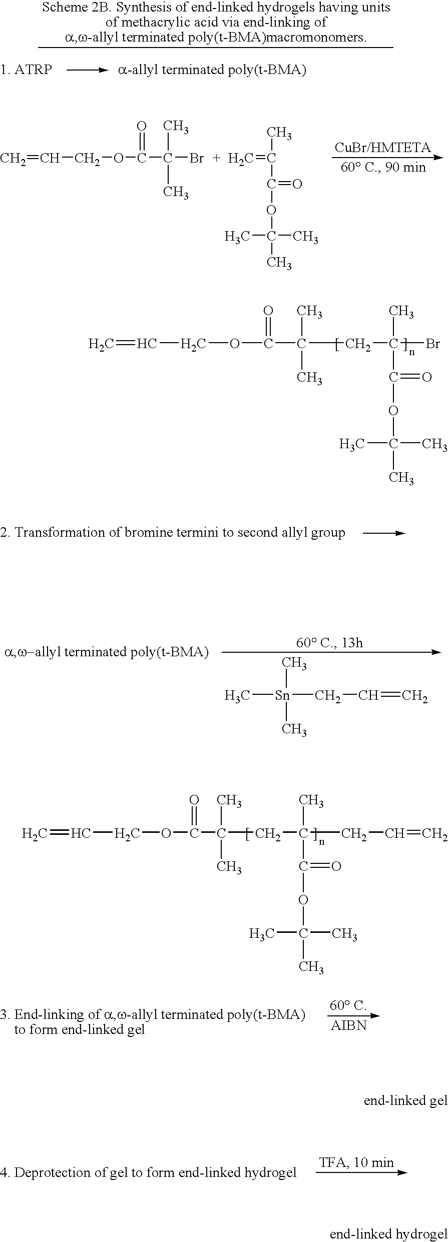

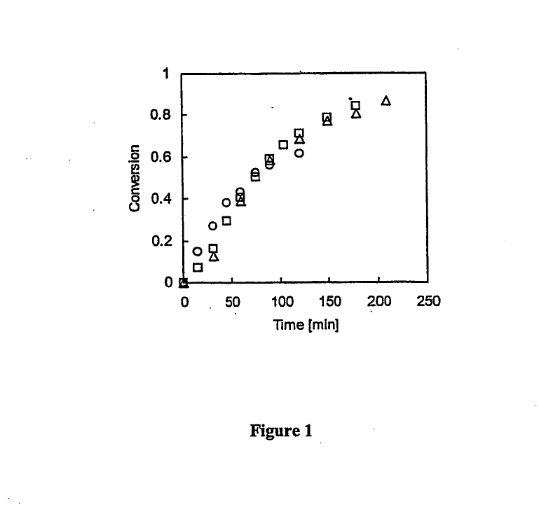

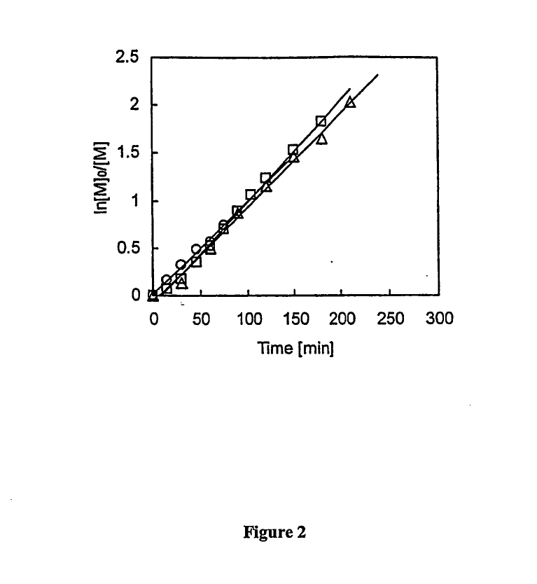

The ATRP reaction of t-butyl methacrylate (t-BMA) with the Cu(I)-HMTETA complex was studied in different solvents. In tetrahydrofuran (THF), benzene and acetone the reaction proceeded at 60° C., 60° C. and 50° C., respectively, the monomer:solvent volume ratio was maintained at 1:1 and the [monomer]:[Initiator]:[CuBr]:[HMTETA] molar ratio was maintained at 50:1:1:1. FIG. 1 shows plots of monomer conversion vs. reaction time for the ATRP of t-BMA in THF at 60° C. (□), benzene at 60° C. (Δ) and acetone at 50° C. (ο) under the following conditions: [ABIB]:[CuBr]:[HMTETA]=1:1:1=0.6 mmol, [t-BMA]=30 mmol, and t-BMA:solvent ratio by volume=1:1 (HMTETA=N,N,N′,N′,N″,N″-hexamethyltriethylenetetraamine). FIG. 2 shows a plot of ln ([M]₀/[M]) vs. reaction time for the ATRP of t-BMA in THF at 60° C. (□), benzene at 60° C. (Δ) and acetone at 50° C. (ο) under the same conditions as described for FIG. 1. The plot of FIG. 2 is linear for each solvent, indicating a first-order reaction with respect to the monomer. As indicated by the plot of FIG. 2, the rates of reactions in the three solvents are very similar, even though reactions in THF and acetone were more homogeneous compared to the reaction in non-polar benzene. Monomer conversion was calculated from a GC chromatogram using a GC standard and was found to be approximately 80% after 3 hours of reaction time for THF and benzene. In acetone the reaction stopped after about 2 h and ˜60% conversion due to the very high viscosity of the reaction mixture, which could no longer be stirred at that point.

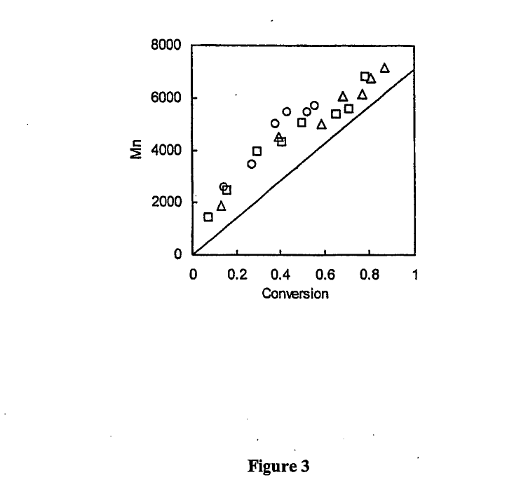

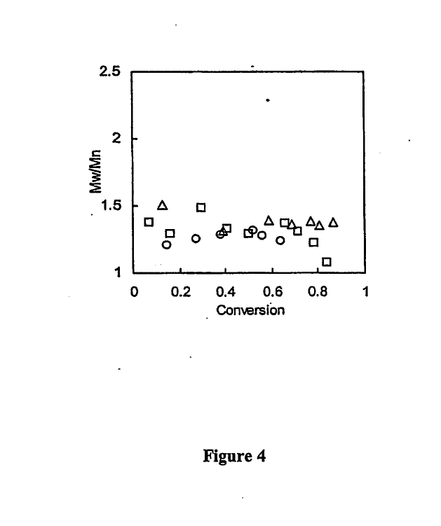

The α-allyl,ω-halogen terminated macromonomers were, characterized by molecular weight measurements using Gel Permeation Chromatography (GPC). FIG. 3 shows a plot of number average molecular weight Mₙ vs. monomer conversion for the ATRP of t-BMA in THF at 60° C. (□), benzene at 60° C. (Δ) and acetone at 50° C. (ο) under the following conditions: [ABIB]:[CuBr]:[HMTETA]=1:1:1=0.6 mmol, [t-BMA]=30 mmol, and t-BMA:solvent ratio by volume=1:1. The solid line represents the theoretical value of Mₙ. The Mₙ values increase linearly with monomer conversion, which is consistent with reaction of the monomer with increasingly large macromonomer chains as the reaction progresses. FIG. 4 shows a plot of M_{w}/Mₙ vs. monomer conversion for the ATRP of t-BMA in THF at 60° C. (□), benzene at 60° C. (Δ) and acetone at 50° C. (ο) under the same conditions as described for FIG. 3. The decreasing value of the polydispersity index in FIG. 4, similarly to the increasing Mₙ values of FIG. 3, with increasing conversion is consistent with reaction of the monomer with increasingly large macromonomer chains as the reaction progresses.

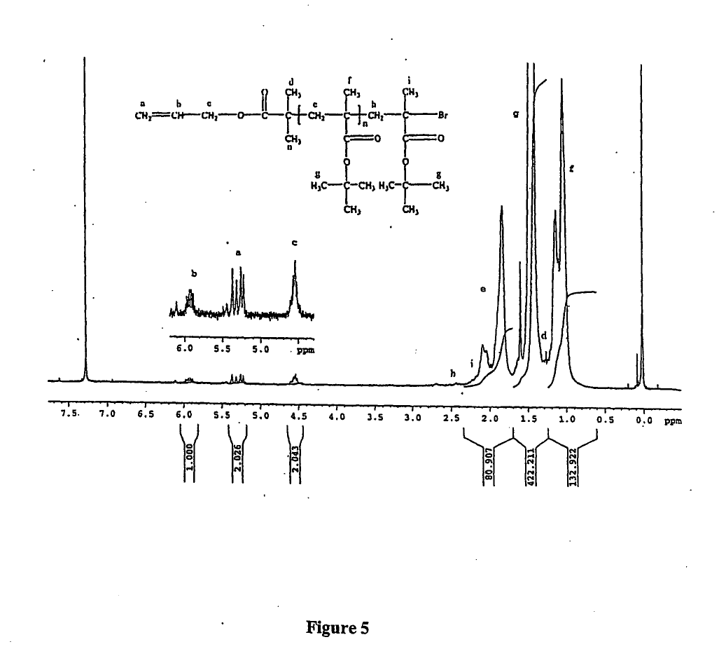

The α-allyl,ω-halogen terminated macromonomers were also characterized by ¹H NMR spectroscopy. FIG. 5 shows a ¹H NMR spectrum of an α-allyl,ω-halogen terminated poly(t-BMA) macromonomer prepared under the following conditions: [ABIB]:[CuBr]:[HMTETA]=1:1:1=0.6 mmol, [t-BMA]=30 mmol, t-BMA:THF ratio by volume=1:1, reaction temperature=60° C., and reaction time=3 h. The spectrum shows the characteristic peaks of t-butyl -CH3 protons (δ=1.4-1.5 ppm), methacrylate α-CH₃ protons (δ=1.0-1.2 ppm), backbone —CH₂— protons (δ=1.8-1.85 ppm) and allyl end group protons of CH₂=(δ=5.2-5.4 ppm), ═CH—(δ=5.9-6.0 ppm) and —CH₂— groups (δ=4.5-4.7 ppm). The value of Mₙ was also calculated from the ¹H NMR spectrum from the ratio of the signal intensity of the t-butyl —CH₃ protons to the signal intensity of the allyl end group protons. The resulting Mₙ value was found to be in very good agreement with the Mₙ value found by GPC (M_{nGPC}/M_{nNMR}≈1.05).

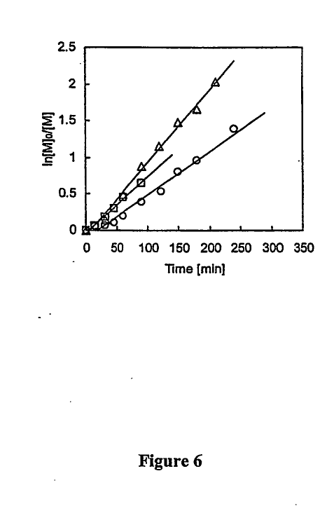

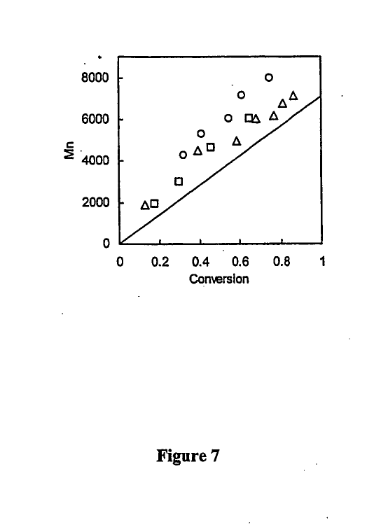

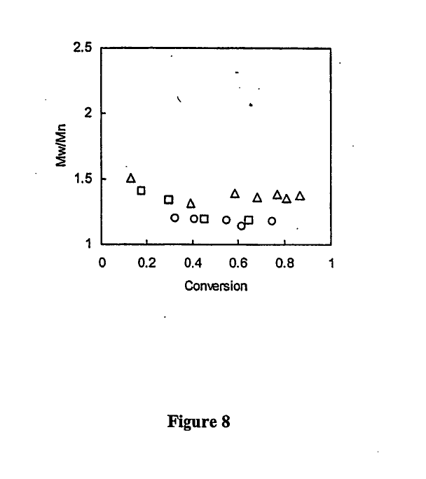

The α-allyl,ω-halogen terminated macromonomers are formed as illustrated in the reaction of step 1 in Scheme 2, where the halogen is bromine. However, as discussed in Bednarek, M., Biedron, T. and Kubisa, P. Macromolecular Rapid Communications, Vol. 20 (1999), pp. 59-65, this reaction may be accompanied by side reactions that lead to the elimination of bromine, so that some of the macromonomers are not bromine terminated and therefore cannot react with compounds containing transferable allyl groups to replace bromine with allyl as shown in step 2 of Scheme 2. For the ATRP reaction of a mixture of equal concentrations of ABIB, copper (I) bromide and HMTETA, and of a 1:1 t-BMA:THF ratio by volume, 57% of the macromonomers were found to be bromine-terminated. To increase the percentage of bromine terminated macromonomer chains, the ratio between the catalyst and the initiator molar concentrations was decreased to 1:2; the solvent: t-BMA ratio by volume was decreased to 1:2; and the reaction temperature was maintained at a temperature between about 50° C. and about 60 ° C. FIGS. 6, 7 and 8 show plots of ln ([M]₀/[M]) vs. reaction time, Mₙ vs. monomer conversion, and M_{w}/Mₙ vs. monomer conversion, respectively, for the ATRP of t-BMA in benzene at 60° C. under the following conditions: [ABIB]:[CuBr]:[HMTETA]=1:1:1=0.6 mmol, [t-BMA]=30 mmol, and t-BMA:benzene ratio by volume=1:1 (Δ); [ABIB]:[CuBr]:[HMTETA]=1:0.5:0.5 (ο) and t-BMA:benzene ratio by volume=1:1 (Δ); and [ABIB]:[CuBr]:[HMTETA]=1:0.5:0.5 and t-BMA:benzene ratio by volume=1:0.5 (□). The solid line in FIG. 7 represents the theoretical value of Mₙ. The combination of lower catalyst amounts and lower solvent amounts result in a decreased rate of polymerization, as shown by the data in FIG. 6, an increased efficiency of the catalyst, leading to a higher Mₙ value, as shown by the data in FIG. 7, and a narrowed polydispersity index, as shown by the data in FIG. 8.

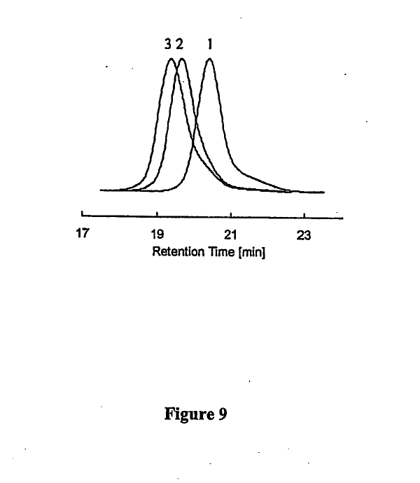

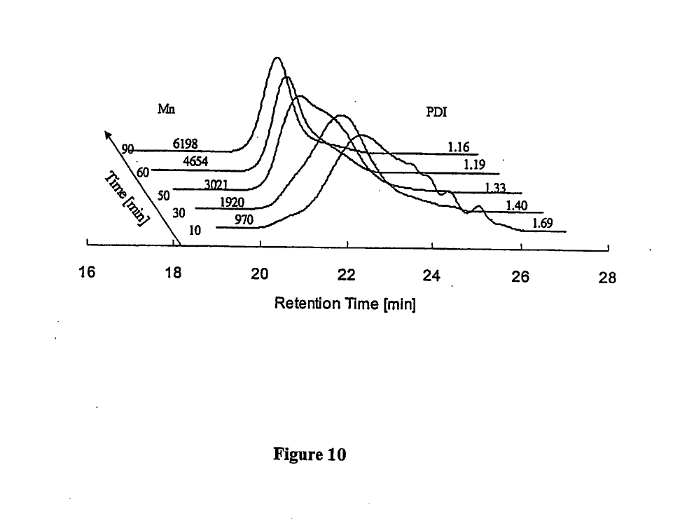

Lower catalyst amounts and lower solvent amounts lead to an increase in the percentage of bromine termination in the α-allyl,ω-bromine terminated macromonomer. This was shown by using the macromonomer as an initiator in a reaction mixture containing a 1:1 copper bromide-HMTETA complex and monomeric t-BMA to give an extended macromonomer. FIG. 9 shows a Gel Permeation Chromatography (GPC) of a poly (t-BMA) macromonomer (peak 1), an extended poly (t-BMA) macromonomer (peak 2), and a further extended poly (t-BMA) macromonomer (peak 3). The macromonomer of peak 1 was prepared by ATRP using ABIB as the initiator under the following conditions: [ABIB]:[CuBr]:[HMTETA]=1:0.5:0.5, [ABIB]=0.6 mmol, [t-BMA]=30 mmol, t-BMA/benzene ratio by volume=1/0.5, reaction temperature=60° C., and reaction time=1.5 h. The molecular weight profile of the macromonomer of peak 1 as a function of reaction time is shown in FIG. 10. At the end of the reaction the macromonomer had a Mₙ of 6198 and a polydispersity index (PDI) of 1.16. The extended macromonomer of peak 2 was prepared by ATRP by using the macromonomer of peak 1 as an initiator under the following conditions: [peak 1 macromonomer]:[CuBr]:[HMTETA]=1:1:1 0.098 mmol and [t-BMA]=9.8 mmol. The reaction proceeded in the absence of solvent at 60° C. for 20 min. This macromonomer had a Mₙ of 11081 and a PDI of 1.19. The further extended macromonomer of peak 3 was prepared by ATRP by using the macromonomer of peak 2 as an initiator under the following conditions: [peak 2 macromonomer]:[CuBr]:[HMTETA]=1:1:1=0.098 mmol and [t-BMA]=9.8 mmol. The reaction proceeded in the absence of solvent at 60° C. for 20 min. This macromonomer had a Mₙ of 13656 and a PDI of 1.22.

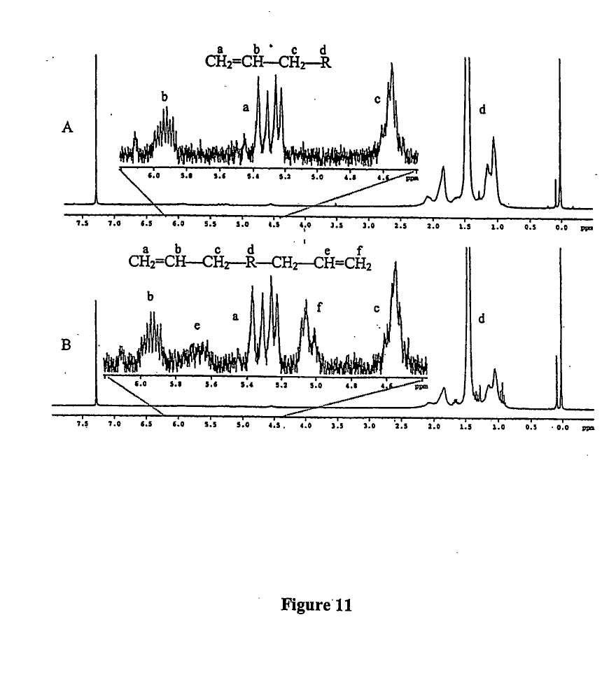

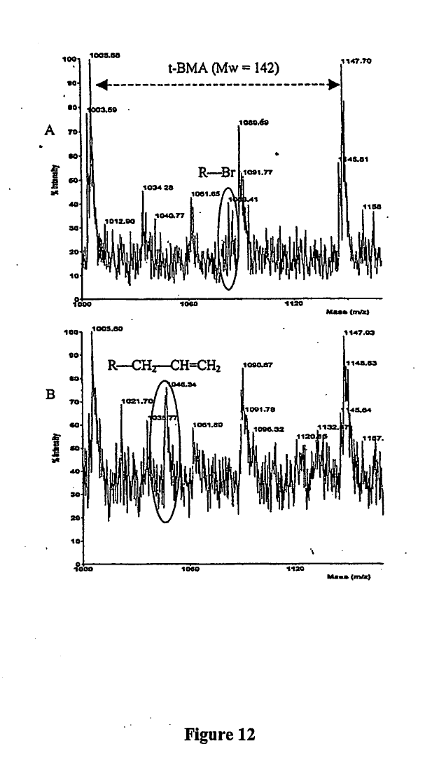

The terminal bromine in the α-allyl,ω-bromine terminated poly(t-BMA) macromonomer is advantageously converted to a second allyl end group by reaction with allyltributyltin. The reaction is carried out at 60° C. for 13 hours to give the corresponding α,ω-allyl terminated poly(t-BMA) macromonomer, which is precipitated by addition of the reaction mixture to a ten-fold excess of a mixture of methanol and deionized water in equal parts by volume. The structure of the product was confirmed by ¹H NMR spectroscopy. In particular, the ¹H NMR spectrum of FIG. 11B shows the appearance of new peaks which correspond to the signals of the CH₂=(δ=5.0-5.1 ppm) and —CH— (δ=5.6-5.8 ppm) protons of the newly introduced ω-allyl end group. These signals are not present in the ¹H NMR spectrum of the α-allyl,ω-bromine terminated poly(t-BMA) macromonomer, shown in FIG. 11A. The introduction of the second allyl group was also shown by comparison of the Matrix Assisted Laser Desorption/Ionization Time of Flight (MALDI-TOF) spectrum of the α-allyl,ω-bromine terminated poly(t-BMA) macromonomer, shown in FIG. 12A, and the MALDI-TOF spectrum of the α,ω-allyl terminated poly(t-BMA) macromonomer, shown in FIG. 12B. The MALDI-TOF spectrum of the α-allyl,ω-bromine terminated poly(t-BMA) macromonomer in FIG. 12A shows doublet peaks corresponding to molecular fragments containing the ⁷⁹Br and ⁸¹Br isotopes, respectively. In contrast, no doublet peaks were detected in the MAIDI-TOF spectrum in FIG. 12B.

Hydrolysis of the ester groups of the α,ω-allyl terminated macromonomer having a multiplicity of units of the ester of the α,β-unsaturated carboxylic acid gives the corresponding α,ω-allyl terminated macromonomer having a multiplicity of units of the α,β-unsaturated carboxylic acid. For example, removal of the t-butyl protecting groups in the α,ω-allyl terminated poly(t-BMA) macromonomer gives the corresponding α,ω-allyl terminated poly(MAA) macromonomer. Removal of t-butyl ester groups of poly-t-butyl acrylate (poly(t-BA)) polymers by acid hydrolysis of the ester has been described by Coca, S., Davis, K. A. and Matyjaszewski, K., Polymer Preprints, Vol. 38 (1997), p. 689 (incorporated herein by reference), who used an excess of concentrated hydrochloric acid in refluxing dioxane for 4-6 hours. Without wishing to be bound by any theory or mechanism, this reaction is believed to occur via the mechanism shown in Scheme 3 shown hereinbelow.

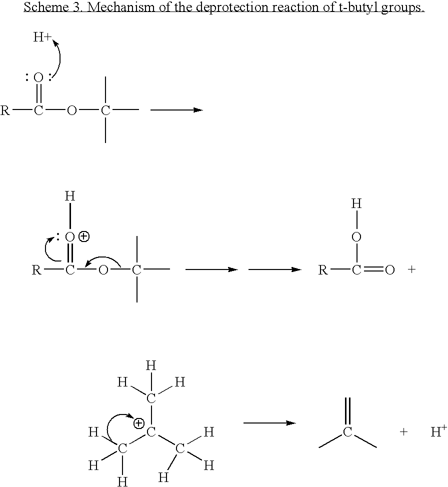

The method of Coca et al., however, was not successful for poly(t-BMA) macromonomers. This result is believed to be due to the greater hydrophobicity of methacrylate polymers relative to the acrylate analogs and to the resulting suppression of the reaction of hydrochloric acid with the ester groups. In contrast, the deprotection of poly(t-BMA) macromonomers was successfully conducted using 95% TFA, which is a known reagent for the deprotection of t-butyl groups of esters in solid phase synthesis. See Novabiochem 2000 Catalog, p. B 10. The α,ω-allyl terminated poly(t-BMA) macromonomer obtained from the reaction described above was dissolved in 95% TFA, and after 10 minutes the deprotection reaction was complete. The excess of TFA was removed by flushing the sample with argon. The resulting deprotected macromonomer was purified via Soxhlet extraction in acetone and dried in a vacuum oven.

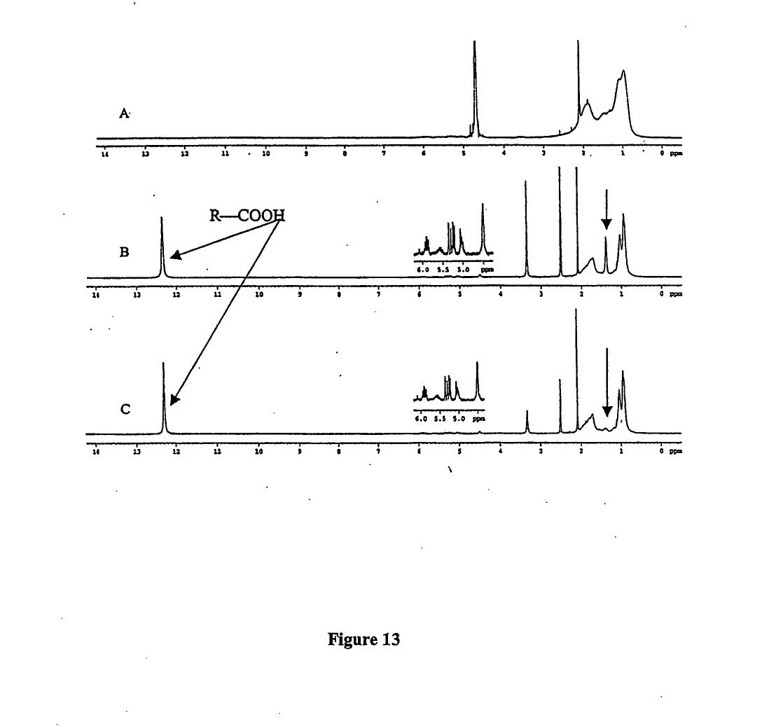

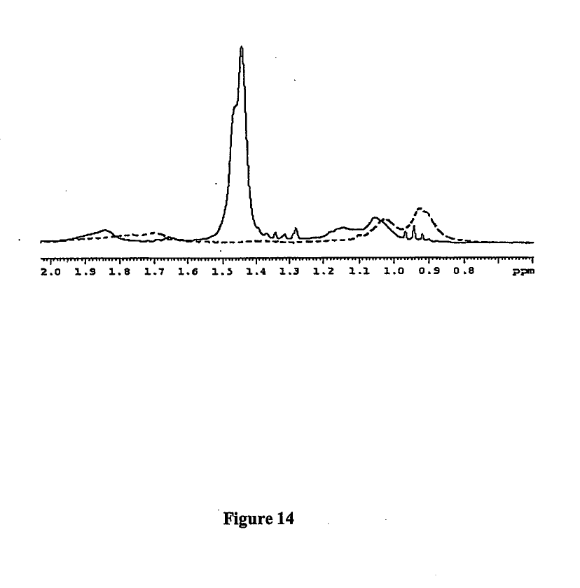

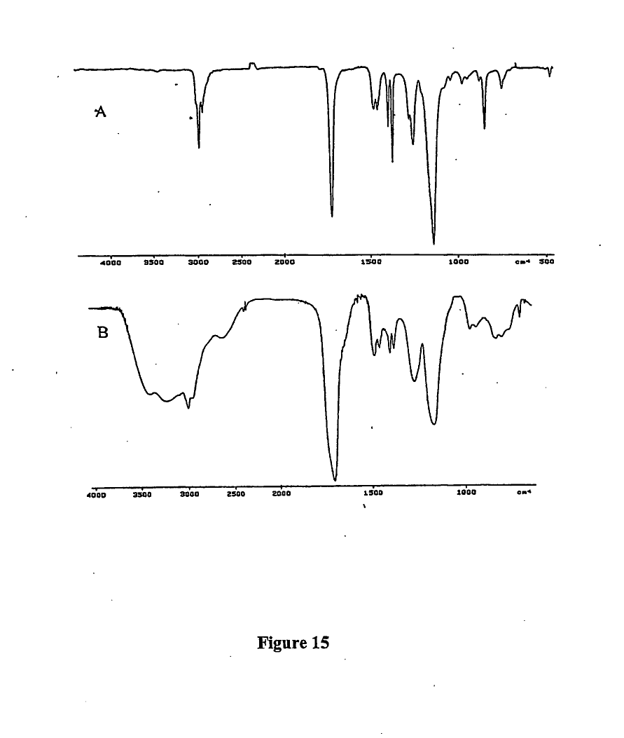

The ¹H NMR spectrum of the product in D₂0 confirmed removal of the t-butyl groups. FIG. 13A shows a ¹H NMR spectrum in D₂O of an α,ω-allyl terminated polymethacrylic acid (poly(MAA)) macromonomer prepared by reaction of the corresponding poly(t-BMA) macromonomer with 95% TFA. As shown in FIG. 13A, the spectrum does not show a sharp peak at δ=1.4 ppm, corresponding to the t-butyl group, as was present in the ¹H NMR spectrum of the reactant poly(t-BMA) macromonomer shown in FIG. 11. The acidic —COOH proton which is formed by cleavage of the t-butyl group is not observed in the ¹H NMR spectrum of FIG. 13A due to exchange with D₂O. FIG. 13B shows a ¹H NMR spectrum in deuterated DMSO of the α,ω-allyl terminated poly(MAA) macromonomer. The d-DMSO ¹H NMR spectrum of FIG. 13B, in contrast to the spectrum of FIG. 13A, shows a —COOH peak at δ=12.3 ppm and also reveals the presence of a small amount of unreacted t-butyl group at δ=1.4 ppm. The incomplete deprotection is believed to be due to a small amount of water in 95% TFA. When the reaction was repeated using concentrated (99%) TFA, removal of the t-butyl group was complete as shown by the ¹H NMR spectrum in d-DMSO of the resulting product, which is shown in FIG. 13C. Magnification of the ¹H NMR spectrum of FIG. 13C in the 0.8-2.0 ppm region, as shown in FIG. 14, confirmed the disappearance of the t-butyl groups. In particular, the solid line in FIG. 14, which represents the spectrum of the reactant α,ω-allyl terminated poly(t-BMA) macromonomer, shows the presence of t-butyl proton signals which are absent in the spectrum of the product obtained from the reaction of the reactant macromonomer with 99% TFA. The presence of a carboxylic acid group in the product of the reaction was also demonstrated by FT-IR analysis of the product, which is shown in FIG. 15B, and which shows a broad absorbance from 2800 to 3600 cm⁻¹, which is typical of a carboxylic acid group.

End-linking of the α,ω-allyl terminated macromonomer having a multiplicity of units of the α,β-unsaturated carboxylic acid is accomplished by treating the macromonomer with heat, visible, or ultraviolet radiation to give an end-linked hydrogel having a multiplicity of units of the α,β-unsaturated carboxylic acid, a new polymeric homogeneous network with controlled mechanical properties. The reaction may be performed using a method similar to the free-radical polymerization approach described for the photopolymerization of polyethylene glycol (PEG) macromonomers in U.S. Pat. No. 5,801,033, which is incorporated herein by reference. A first mixture containing an α,ω-allyl terminated macromonomer having a multiplicity of units of the α,β-unsaturated carboxylic acid, a radical initiator, and optionally an organic solvent or water is formed, and then treated with heat, ultraviolet radiation, or visible radiation to produce a second mixture containing the hydrogel. Formation of the hydrogel may be monitored by standard methods, such as, for example, thin layer chromatography. The hydrogel is then optionally separated from the second mixture. The concentrations of the macromonomer and of the radical initiator are typically in the ratio of about 100:1. The reaction may be carried out in the absence of a solvent. Alternatively, an organic solvent or water may be present, and the concentration of the macromonomer is in the range of about 2 g/100 ml of solvent to about 3 g/100 ml of solvent. When water is used as the solvent, the reaction requires the pH of the first mixture to be maintained at a value greater than about 2.5. Heat treatment of the mixture may be conducted using 2,2′-azobis(2-methyl-propionitrile) (AIBN) as the radical initiator and a reaction temperature of 60° C. Ultraviolet radiation treatment may be conducted using 2,2-dimethoxy-2-phenyl acetophenone (DMPA) as the radical initiator and ultraviolet light having a wavelength between 356 nm and 514 nm, preferably 365 nm, at a temperature of about 25° C. The ultraviolet light source may be, for example, a Nd-YAG laser, an excimer laser, or a mercury lamp or xenon lamp preferably coupled with a filter which absorbs the visible light component. Visible light treatment may be conducted a temperature of about 25° C. using a radical initiator selected from ethyl eosin or eosin Y, where the mixture containing an α,ω-allyl terminated macromonomer having a multiplicity of units of the α,β-unsaturated carboxylic acid and a radical initiator further comprises a nitrogen based compound. The structures of ethyl eosin and eosin Y are shown below. The nitrogen based compound acts as a co-catalyst and may be an alkylamine. Triethylanine, triethanolamine, and ethanolamine are especially suitable co-catalysts. The visible light source may be, for example, an argon ion laser, or a mercury or xenon lamp preferably coupled with a filter which absorbs the ultraviolet light component.

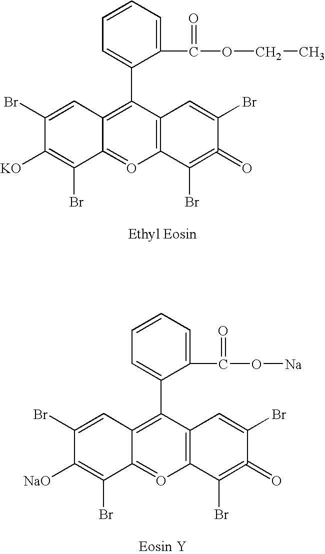

Since the end-linked hydrogel having a multiplicity of units of the α,β-unsaturated carboxylic acid is usefull as a coating agent, the end-linking reaction may be conveniently performed directly on the surface of the article to be coated. The surface is coated or dipcoated with the first mixture containing the macromonomer, the radical initiator and optionally an organic solvent or water, and the mixture coating is then treated with heat, ultraviolet radiation, or visible radiation to form a coating containing the hydrogel on the surface of the article.

In accordance with another embodiment of the invention, end-lining of the α,ω-allyl terminated macromonomer having a multiplicity of units of the ester of the α,β-unsaturated carboxylic acid is accomplished by treating the macromonomer with heat, visible, or ultraviolet radiation to give a mixture containing an end-linked gel having a multiplicity of units of the ester of the α,β-unsaturated carboxylic acid. The reaction may be performed using substantially similar reaction conditions and radical initiators as described above for the end-linking of the α,ω-allyl terminated macromonomer having a multiplicity of units of the α,β-unsaturated carboxylic acid. The mixture containing the end-linked gel is then reacted with a mixture containing TFA to form a hydrogel having a multiplicity of units of the α,β-unsaturated camboxylic acid using substantially similar reaction conditions as described above for the analogous reaction of a macromonomer having a multiplicity of units of the ester of the α,β-unsaturated carboxylic acid. The end-lined hydrogel is then separated from the reaction mixture.

The hydrogels formed from the end-linking reactions described above have a multiplicity of crosslinked sites which define segments having a multiplicity of the α,β-unsaturated carboxylic acid. Each of these segments has a molecular weight between about 1,000 and 10,000.

The invention is further described in the following examples, which are intended to be illustrative and not limiting of the scope of the invention.

### EXAMPLES

Purification methods. t-butyl methacrylate (t-BMA, Aldrich 98%) and benzene (Fisher) were dried over CaH₂ (Aldrich 90-95%, powder) and then vacuum distilled. Tetrahydrofuran (THF, Acros HPLC grade) was vacuum distilled from purple Na/benzophenone. Copper bromide (CuBr, Aldrich 98%) was purified under argon blanket by stirring in glacial acetic acid, followed by filtering and washing with absolute ethanol and ethyl ether, and then dried under vacuum. Allyl 2-bromoisobutyrate (ABIB, Aldrich 99%), N,N,N′,N′,N″,N″-hexamethyltriethylenetetraamine (HMTETA, Aldrich 97%), allyltributyltin (ATBT, Aldrich 97%), dodecane (Aldrich, anhydrous 99+%), aluminum oxide (alumina, Aldrich, activated) and trfuoroacetic acid (TFA, Aldrich 99%) were all used as received.

Characterization of reaction products. Monomer conversion was determined using a Hewlett-Packard 5890 Gas Chromatograph (GC) equipped with a J&W DBS column (25 m×0.25 mm×1 μm). Injector and detector temperatures were 220° C. and 280° C., respectively, with a heating rate of 20° C./min. samples were held isothermally at 40° C. for 2 min and then at 220° C. for 10 min.

Molecular weights and polydispersitics were estimated using GPC equipment consisting of a Kontes Ultra-Ware reservoir fitted with a 5-valve recirculation head, a Knauer WellChrom MiniStar K-500 A4040 pump fitted with a 10 ml/min pump head, a Rheodyne model 7125 injector, a Groton GTI/SpectroVision FD-500 Fluorescence Detector and a Knauer WellChrom K-2300 Refractive Index (RI) detector. Two 300×7.5 mm PLgel 5 μm MIXED-C columns and a 300×7.5 mm PLgel μm 100 Å column were used in series with THF (1 mL/min) as the eluent against linear polystyrene standards.

Molecular weight and polymer characterization results were confirmed using ¹H NMR spectroscopy on a Bruker 400 MHz instrument.

IR measurements were performed using a KBr pellet on Perkin Eblmer FT-IR Spectrometer PARAGON 1000.

MAIDI-TOF mass spectra were recorded with Voyager-DE (AB Applied Biosystems, Framinghar, Mass.) mass spectrometer equipped with nitrogen laser 337 mn (3 ns pulse width) using dihydroxybenzoic acid as a matrix. Positive ion MALDI-TOF spectra were acquired using delayed-extraction ion source and linear mode with accelerating voltage at 20 kV.

### Example 1

### Synthesis of α-allyl,ω-bromine Terminated Poly(t-BMA) Macromonomer via ATRP

CuBr (44.1 mg, 0.3 mmol) was added under argon to a dry round-bottom flask (rbf) equipped with a stirrer bar. The flask was sealed with a rubber septum, degassed and back-filled with argon three times and left under argon. Deoxygenated benzene (2.5 ml) and HMTETA (83.6 μL, 0.3 mmol) were added via argon-purged syringes and stirred until the copper (I) bromide-HMTETA complex was formed, as indicated by a change from a cloudy white suspension to a clear, colorless solution and then to a slightly greenish suspension Then t-BMA (5 ml, 30 mmol) and dodecane (0.2 ml, GC standard) were added under argon and the reaction vessel was placed in an oil bath maintained at 60° C. After the addition of ABIB (97.8 μL, 0.6 mmol), an initial sample was taken at time t=0 and the reaction was stirred until stirring stopped after about 90 minutes due to the formation of a very viscous dark green suspension. GC analysis showed 65% of monomer conversion. The reaction mixture was characterized by GPC: Mₙ=6198, M_{w}/Mₙ=1.16; by ¹H NMR (CDCl₃), which gave the following δ values: t-butyl —CH₃ protons: 1.4 -1.5 ppm, methacrylate α-H3 protons: 1.0-1.2 ppm, backbone —CH₂-protons: 1.8-1.85 ppm; allyl end group protons: CH₂=: 5.2-5.4 ppm, ═CH—: 5.9-6.0 ppm, —CH₂—: 4.5-4.7 ppm); and by MALDI-TOF: α-allyl,ω-bromine terminated poly(t-BMA) macromonomer—major series: m/z=[n×142 (t-BMA) +79/81 (Br)+127 (initiator fragment)] and minor series: m/z=[n×(142-57)+79/81+127] that is believed to correspond to the loss of t-butyl group (M_{w}=57) during preparation of the sample by treating with acid. The reaction mixture was subjected to the next step in the reaction sequence, described below, without first isolating the α-allyl,ω-bromine terminated poly(t-BMA) macromonomer from the reaction mixture.

### Example 2

### Synthesis of α,ω-allyl Terminated Poly(t-BMA) Macromonomer

A small amount of benzene (2.5 ml) was injected into the round bottom flask to dissolve the macromonomer formed in the manner described in Example 1. Allyltributyltin (571 μL, 1.8 mmol) was then added, and the reaction mixture was heated for 13 hrs at 60° C. Acetone (5 ml) was added to stop the reaction. The reaction mixture was passed through a column of alumina to remove the copper-containing catalyst, and a 10-fold excess by volume of a mixture of MeOH/deionized water in equal parts by volume was added to the mixture, causing the α,ω-allyl terminated poly(t-BMA) macromonomer to precipitate. The precipitation procedure was repeated two times to remove residual monomer. The product macromonomer was formed as fine white powder and dried under vacuum overnight. The macromonomer was characterized by ¹H NMR spectroscopy (CDCl₃), which gave the following δ values: t-butyl —CH₃ protons: 1.4-1.5 ppm; methacrylate α-CH₃ protons: 1.0-1.2 ppm; backbone —CH₂— protons: 1.8 -1.85 ppm; α-allyl end group protons: CH₂═: 5.2 -5.4 ppm; —CH—: 5.9-6.0 ppm; —CH₂—: 4.5-4.7 ppm; ω-allyl end group protons: CH₂═: 5.0-5.1 ppm; —CH—: 5.6-5.8 ppm. The macromonomer was also characterized by MALDI-TOF, which gave the following results: major series m/z=[n×142 (t-BMA)+41 (—CH₂—CH═CH₂)+127 (radical initiator)] and minor series m/z=[n×(142-57)+41+127].

### Example 3

### Extension of Polymer Chains

A mixture containing a bromo-terminated poly(t-BMA) macromonomer having an allyl end group (Mₙ=7130, M_{w}/Mₙ=1.18, 0.7 g, 98 μmol) and copper (I) bromide (0.0148 g, 98 μmol) was added to a 50 mL round bottom flask, sealed with a rubber septum, degassed, and back-filled with argon three times. Deoxygenated t-BMA monomer (1.6 mL 9.8 mmol) and dodecane (GC standard 0.1 mL) were added via a purged syringe. The macromonomer was dissolved and HMTETA was introduced (26.8 μL, 98 μmol) to form the copper bromide-HMTETA complex as evidenced by the formation of a greenish cloudy suspension. A first sample was removed from the reaction mixture at time=0 and the round bottom flask was placed in an oil bath thermostated at 60° C. The reaction mixture was stirred for about 20 minutes, which led to the formation of a very viscous mixture which could not be stirred further. A second sample was removed from the reaction mixture. Comparison of a GC analysis of the first and second sample showed 60% of monomer conversion in the second sample. The reaction mixture was then dissolved in acetone, passed through a column of alumina to remove the copper bromide catalyst, and added to a 10-fold excess of a mixture of MeOH/deionized water in equal parts by volume to precipitate an extended bromo-terminated poly(t-BMA) macromonomer having an allyl end group and having Mₙ=11081 and M_{w}/Mₙ=1.19. After filtration, the macromonomer was dried in a vacuum oven. The procedure was repeated with the extended macromonomer as an initiator. A further extended polymer was formed having Mₙ=13656 and M_{w}/Mₙ=1.22.

### Example 4

### Preparation of α,ω-allyl Terminated Poly(MAA) Macromonomer

The α,ω-allyl terminated poly(t-BMA) macromonomer prepared as described in Example 2 was dissolved in a minimum amount of 99% TFA at room temperature. After 10 minutes the removal of the t-butyl protecting groups was complete. The TFA was removed by flushing the mixture with argon. The deprotected macromonomer was purified by Soxhlet extraction in acetone, followed by drying under vacuum over night. The ¹H NMR (d-DMSO) spectrum of the deprotected and purified macromonomer showed disappearance of the t-butyl proton peaks at δ32 1.4-1.5 ppm and the appearance of a new peak at δ=12.3 corresponding to the —COOH proton. The presence of a —COOH group was confirmed by an FT-IR (KBr pellet) which showed the characteristic absorbance of a carboxylic acid group between 2800 and 3600 cm⁻¹.

### Example 5

### Preparation of the End-Linked Gel

0.2 g of the α,ω-allyl terminated poly(t-BMA) macromonomer prepared in the manner described in Example 2 and 0.002 g of AIBN were mixed in 8 ml of benzene, and the mixture was heated to a temperature of 60° C. and maintained at 60° C. overnight to form the end-linked gel having a multiplicity of units of the t-butyl ester of methacrylic acid. The gel was then washed with acetone to remove impurities. The swelling ratio was 4.05.

### Example 6

### Preparation of the End-Linked Hydrogel

0.2 g of the α,ω-allyl terminatedpoly(MAA) macromonomer prepared as described in Example 4 and 0.002 g of AIBN are mixed in 8 ml of water, and the mixture is heated to a temperature of 60° C. and maintained at 60° C. overnight to form the end-linked hydrogel having a multiplicity of units of methacrylic acid. The hydrogel is then washed with water to remove impurities.

It should be understood that various changes and modifications to the exemplary embodiments described herein will be readily apparent to those skilled in the art without departing from the spirit and scope of the general inventive concept defined by the appended claims.

1. A method for making an α,ω-allyl-terminated macromonomer comprising a plurality of units of an α,β-unsaturated carboxylic acid, the method comprising:
(a) forming a first mixture containing an ester of an α,β-unsaturated carboxylic acid, a radical initiator comprising an allyl group and a halogen, and a catalyst comprising a transition metal complex, wherein the ester is capable of reacting with a mixture containing trifluoroacetic acid to form the α,β-unsaturated carboxylic acid;
(b) stirring the first mixture to form a second mixture containing an α-allyl,ω-halogen terminated macromonomer comprising a plurality of units of the ester of the α,β-unsaturated carboxylic acid;
(c) adding to the second mixture a third mixture containing a compound having at least one transferable allyl group to form a fourth mixture containing an α,ω-allyl terminated macromonomer comprising a plurality of units of the ester of the α,β-unsaturated carboxylic acid;
(d) separating the α,ω-allyl terminated macromonomer formed in step (c) from the fourth mixture;
(e) mixing the α,ω-allyl terminated macromonomer formed in step (c) with a mixture containing trifluoroacetic acid to form a fifth mixture containing an α,ω-allyl terminated macromonomer comprising a plurality of units of the α,β-unsaturated carboxylic acid; and
(f) separating the α,ω-allyl terminated macromonomer formed in step (e) from the fifth mixture.

2. The method of claim 1, wherein the α,ω-allyl terminated macromonomer formed in step (e) has a molecular weight between about 1,000 and about 10,000.

3. The method of claim 1, wherein the α,β-unsaturated carboxylic acid is an α,β-unsaturated carboxylic acid having a C_{β}═C_{α} double bond which is polymerizable.

4. The method of claim 3, wherein the α,β-unsaturated carboxylic acid is selected from the group consisting of acrylic acid and methacrylic acid.

5. The method of claim 4, wherein the α,β-unsaturated carboxylic acid is methacrylic acid.

6. The method of claim 1, wherein the ester of the α,β-unsaturated carboxylic acid comprises the group having the formula III 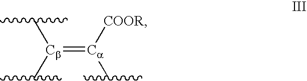
wherein R is selected from a t-butyl group and a group having the formula Ar—(CR₁R₂)—,
wherein Ar is an aryl group and R₁ and R₂ are each independently selected from the group consisting of hydrogen, an alkyl group and an aryl group

7. The method of claim 6, wherein the ester of the α,β-unsaturated carboxylic acid is selected from the group consisting of t-butyl methacrylate and phenylmethyl methacrylate.

8. The method of claim 7, wherein the radical initiator is allyl-2-bromoisobutyrate.

9. The method of claim 1, wherein the transition metal complex is a complex of a transition metal selected from the group consisting of molybdenum, chromium, rhenium, ruthenium, iron, rhodium, nickel, palladium and copper.

10. The method of claim 1, wherein the transition metal complex comprises a ligand selected from the group consisting of amines, phosphines, arenes, and monovalent anions.

11. The method of claim 10, wherein the ligand is selected from the group consisting of C₆H₄(CH₂NMe₂)₂, 2,6-bis[(dimethylamino)methyl]pyridine, N(nBu)₃, phenanthroline, substituted or unsubstituted picolylamine, N,N,N′,N′,N″,N″-hexamethyltriethylenetetraamine, P(nBu)₃, triphenylphosphine, isopropyltoluene, indenyl, cyclopentadienyl, chloride, bromide, and iodide.

12. The method of claim 1, wherein the transition metal complex is selected from copper bromide and a complex of copper bromide and N,N,N′,N′,N″,N″-hexamethyltriethylenetetraamine in a 1:1 molar ratio.

13. The method of claim 1, wherein the compound containing at least one transferable allyl group is an allylmetal.

14. The method of claim 13, wherein the allylmetal is allyltributyltin.

15. The method of claim 1, wherein the first mixture contains an organic solvent.

16. The method of claim 15, wherein the organic solvent is selected from the group consisting of acetone, benzene and tetrahydrofuran.

17. The method of claim 16, wherein the organic solvent is selected from one of tetrahydrofuran and benzene, and the stirring in step (b) is carried out at a temperature of about 60° C.

18. The method of claim 16, wherein the organic solvent is acetone and the stirring in step (b) is carried out at a temperature of about 50° C.

19. The method of claim 15, wherein the ester of the α,β-unsaturated carboxylic acid and the organic solvent are present in the first mixture in a ratio of about 2:1 by volume.

20. The method of claim 1, wherein the first mixture does not contain a solvent.

21. The method of claim 1, wherein the ester of the α,β-unsaturated carboxylic acid, the radical initiator, and the catalyst comprising a transition metal complex are in a molar concentration ratio of 50:1:0.5.

22. The method of claim 21, wherein stirring in step (b) is carried out at a temperature ranging from about 50 ° C. to about 60° C.

23. An α,ω-allyl terminated macromonomer comprising a plurality of units of an α,β-unsaturated carboxylic acid.

24. The macromonomer of claim 23, wherein the macromonomer has a molecular weight between about 1,000 and about 10,000.

25. A method for making a macromonomer comprising a plurality of units of an α,β-unsaturated carboxylic acid, the method comprising
(a) mixing a macromonomer comprising a plurality of units of an ester of the α,β-unsaturated carboxylic acid with a first mixture comprising trifluoroacetic acid to form a second mixture comprising the macromonomer comprising a plurality of units of the α,β-unsaturated carboxylic acid; and
(b) separating the macromonomer comprising a plurality of units of the α,β-unsaturated carboxylic acid from the second mixture.

26. The method of claim 25, wherein the macromonomer has a molecular weight between about 1,000 and about 10,000.

27. A method for making end-linked hydrogels comprising a plurality of units of an α,β-unsaturated carboxylic acid, the method comprising:
(a) forming a first mixture containing an α,ω-allyl terminated macromonomer comprising a plurality of units of the α,β-unsaturated carboxylic acid and a radical initiator; and
(b) treating the first mixture with at least one of UV-radiation, visible light, and heat to form a second mixture containing the end-linked hydrogel comprising a plurality of units of the α,β-unsaturated carboxylic acid.

28. The method of claim 27, wherein the first mixture does not contain water.

29. The method of claim 28, wherein the first mixture does not contain a solvent.

30. The method of claim 27, wherein the hydrogel comprises a plurality of crosslinked sites which define segments comprising a plurality of units of the α,β-unsaturated carboxylic acid.

31. The method of claim 30, wherein each segment has a molecular weight between about 1,000 and about 10,000.

32. The method of claim 27, wherein the α,β-unsaturated carboxylic acid is an α,β-unsaturated carboxylic acid having a C_{β}═C_{α} double bond which is polymerizable.

33. The method of claim 32, wherein the α,β-unsaturated carboxylic acid is selected from the group consisting of acrylic acid and methacrylic acid.

34. The method of claim 27, wherein the first mixture is heated to a temperature of maintained at about 60° C., and the radical initiator is 2,2′-azobis(2-methyl-propionitrile).

35. The method of claim 27, wherein the first mixture is treated with ultraviolet radiation having a wavelength between 356 nm and 514 nm and the radical initiator is 2,2-dimethoxy-2-phenyl acetophenone.

36. The method of claim 27, wherein the first mixture is treated with visible light, and the radical initiator is selected from the group consisting of ethyl eosin and eosin Y, and wherein the first mixture further comprises a nitrogen based compound.

37. An end-linked hydrogel comprising a plurality of units of an α,β-unsaturated carboxylic acid, prepared by the method comprising:
(a) forming a first mixture comprising an α,ω-allyl terminated macromonomer comprising a plurality of units of the α,β-unsaturated carboxylic acid and a radical initiator; and
(b) treating the first mixture with at least one of UV-radiation, visible light, and heat to form a second mixture containing the end-linked hydrogel comprising a plurality of units of the α,β-unsaturated carboxylic acid.

38. The method of claim 37, wherein the first mixture further comprises a solvent selected from one of an organic solvent and water.

39. The method of claim 37, wherein the hydrogel comprises a plurality of crosslinked sites which define segments comprising a plurality of units of the α,β-unsaturated carboxylic acid.

40. The method of claim 39, wherein each segment has a molecular weight between about 1,000 and about 10,000.

41. A method for making end-linked hydrogels comprising a plurality of units of an α,β-unsaturated carboxylic acid, the method comprising:
(a) forming a first mixture containing an α,ω-allyl terminated macromonomer comprising a plurality of units of an ester of the α,β-unsaturated carboxylic acid and a radical initiator, wherein the ester is capable of reacting with a mixture comprising trifluoroacetic acid to form the α,β-unsaturated carboxylic acid;
(b) treating the first mixture with at least one of UT-radiation, visible light, and heat to form a second mixture containing an end-linked gel comprising a plurality of units of the ester of the α,β-unsaturated carboxylic acid;
(c) mixing the end-linked gel with a mixture comprising trifluoroacetic acid to form a third mixture containing the hydrogel comprising a plurality of units of the α,β-unsaturated carboxylic acid; and
(d) separating the end-linked hydrogel formed in step (c) from the third mixture.

42. The method of claim 41, wherein the first mixture further contains a solvent selected from an one of an organic solvent and water.

43. The method of claim 41, wherein the hydrogel formed in step (c) comprises a plurality of crosslinked sites which define segments comprising a plurality of units of the α,β-unsaturated carboxylic acid.

44. The method of claim 43, wherein each segment has a molecular weight between about 1,000 and about 10,000.

45. A method for coating a surface with a hydrogel comprising a plurality of units of an α,β-unsaturated carboxylic acid, comprising:
(a) coating the surface with a first mixture containing an α,ω-allyl terminated macromonomer comprising a plurality of units of the: α,β-unsaturated carboxylic acid and a radical initiator; and
(b) treating the coating of the first mixture on the surface with one of UV-radiation, visible light, and heat to form a coating comprising the end-linked hydrogel having a plurality of units of the α,β-unsaturated carboxylic acid.

46. A surface coated with an end-linked hydrogel comprising a plurality of units of an α,β-unsaturated carboxylic acid, wherein the surface is prepared by the method comprising:
(a) coating the surface with a first mixture containing an α,ω-allyl terminated macromonomer comprising a plurality of units of the α,β-unsaturated carboxylic acid and a radical initiator; and
(b) treating the coating of the first mixture on the surface with one of UV-radiation, visible light, and heat to form a coating comprising the end-linked hydrogel having a plurality of units of the α,β-unsaturated carboxylic acid.

47. A method for coating a surface with a hydrogel comprising a plurality of units of an α,β-unsaturated carboxylic acid, comprising:
(a) coating the surface with a first mixture containing an α,ω-allyl terminated macromonomer comprising a plurality of units of an ester of the α,β-unsaturated carboxylic acid and a radical initiator, wherein the ester is capable of reacting with a mixture comprising trifluoroacetic acid to form the α,β-unsaturated carboxylic acid;
(b) treating the coating of the first mixture with at least one of UV-radiation, visible light, and heat to form a coating containing an end-linked gel comprising a plurality of units of the ester of the α,β-unsaturated carboxylic acid; and
(c) treating the coating containing the end-linked gel with a mixture comprising trifluoroacetic acid to form a coating containing the hydrogel comprising a plurality of units of the α,β-unsaturated carboxylic acid.

48. A surface coated with an end-linked hydrogel comprising a plurality of units of an α,β-unsaturated carboxylic acid, wherein the surface is prepared by the method comprising:
(a) coating the surface with a first mixture containing an α,ω-allyl terminated macromonomer comprising a plurality of units of an ester of the α,β-unsaturated carboxylic acid and a radical initiator, wherein the ester is capable of reacting with a mixture comprising trifluoroacetic acid to form the α,β-unsaturated carboxylic acid;
(b) treating the coating of the first mixture with at least one of UV-radiation, visible light, and heat to form a coating containing an end-linked gel comprising a plurality of units of the ester of the α,β-unsaturated carboxylic acid; and
(c) treating the coating containing the end-linked gel with a mixture comprising trifluoroacetic acid to form a coating containing the hydrogel comprising a plurality of units of the α,β-unsaturated carboxylic acid.
